(19) United States
(12) Patent Application Publication
(10) Pub. No.: US 2011/0022447 A1
(43) Pub. Date: Jan. 27, 2011

(54) METHOD AND SYSTEM FOR GIFTING AND PROMOTING PRODUCTS AND SERVICES

(76) Inventor: Michael George Pelaic, Toronto (CA)

Correspondence Address: Michael George Pelaic, 296 Mill Road, Suite PH08, Toronto, ON, M9C 4X8, CA

(21) Appl. No.: 12/844,732

(22) Filed: Jul. 27, 2010

Related U.S. Application Data
(60) Provisional application No. 61/228,874, filed on Jul. 27, 2009.

(51) Int. Cl. G06Q 30/00

(52) U.S. Cl. 705/14.1

(57) ABSTRACT

A method of delivering one or more gift certificates and/or one or more gift cards to recipients over a communication network. The method includes storing a multiple of messages in a message database. A user selects a message from the multiple of messages and stores information of the one or more recipients in an information database. A corresponding advertising information is integrated with the selected message to form a basis for an electronic communication. The advertising information is embedded as a substantive feature of the message selected from the multiple of messages. A message content includes the selected message from the multiple of messages and the corresponding advertising information is transmitted to the one or more recipients via the electronic communication to the wireless communication devices.

### BACKGROUND OF THE INVENTION

1. Field of the Invention

Embodiments of the present invention generally relate to a system for purchasing and delivering gifts for designated recipients, and more particularly, to a method for virally distributing advertisements, and delivering gifts certificates and gift cards to consumers through wireless communication devices.

2. Description of the Related Art

On many occasions, consumers, businesses, credit card holders, and other persons find it desirable to arrange for other persons to receive gifts. Gift cards of fixed denomination and gift certificates are currently being delivered to recipients physically, either person to person or by some postal service or a courier.

One may also find it desirable to mail a gift to another person who is geographically distant. In these and other cases, it is often undesirable to give away or send cash. If lost or stolen, cash is practically unrecoverable. Traveler's checks are also undesirable as they must be purchased at a bank and are not acceptable for many types of purchases. Often, people do not have the gift card or the gift certificate on their person when they would like to redeem it.

In other situations, some employers often need an efficient way to provide employees with rewards on a demand basis.

When gifting nominal amounts, such as $5, the receipt of a nominal amount in a gift card is often perceived as cheap, and not worth carrying because it is more of a nuisance than it is worth. In these and other cases, it is often undesirable to Gift cards are defacto the retailers dollars only to use in their stores or companies (meaning the product or products have been purchased as a gift for someone else to redeem at their leisure). If the card is left in a desk drawer, it tends to not be redeemed before its expiry date or it dormancy date at which time it will lose further value. These and other drawbacks exist to the aforementioned alternatives.

Therefore, there exists a need in the art for a method and system for purchasing and delivering gifts to designated recipients in an efficient manner.

### OBJECT OF THE INVENTION

An object of the invention is to provide an efficient gifting method.

An object of the invention is to provide an efficient system to enable employers to transmit rewards on a demand basis.

An object of the invention is to provide an efficient product and service promotion method.

An object of the invention is to overcome drawbacks in existing gift purchase schemes.

### SUMMARY OF THE INVENTION

Embodiments of present invention generally relate to a method of delivering one or more gift certificates and/or one or more gift cards to recipients over a communication network. The method includes storing a multiple of messages in a message database. The multiple of messages includes information about the one or more gift certificates and/or the one or more gift cards. A user selects a message from the multiple of messages and stores information of the one or more recipients in an information database. A corresponding advertising information is integrated with the selected message to form a basis for an electronic communication. The advertising information is embedded as a substantive feature of the one or more gift certificates and/or the one or more gift cards selected from the multiple of messages. A message content including the selected message from the multiple of messages and the corresponding advertising information is transmitted to the one or more recipients via the electronic communication to the wireless communication devices.

Embodiments of present invention generally relate to a system of delivering one or more gift certificates and/or one or more gift cards to recipients over a communication network. The system includes a host processor operable to transmit a multiple of message contents. The system further includes a message database for storing a multiple of messages and an information database for storing information of the one or more recipients. Each message content includes one or more messages selected from the multiple of messages and advertising information. The advertising information is embedded as a substantive feature of the one or more gift certificates and/or the one or more gift cards selected from the multiple of messages.

In another embodiment of the present invention, the advertising information is integrally associated with the respective message content.

While the invention is described herein by way of example using several embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modification, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

These and other features, benefits and advantages of the present invention will become apparent by reference to the following text figures, with like reference numbers referring to like structures across the views, wherein:

FIG. 1 illustrates a block diagram of a system delivering one or more gift certificates and/or one or more gift cards to one or more recipients over a communication network, in accordance with an embodiment of the present invention;

FIG. 2 illustrates a flow diagram of a method of delivering one or more gift certificates and/or one or more gift cards to one or more recipients over a communication network, in accordance with an embodiment of the present invention;

FIG. 3 illustrates a flow diagram of a method of delivering one or more gift certificates and/or one or more gift cards to one or more recipients over a communication network, in accordance with an alternate embodiment of the present invention;

FIG. 4 illustrates a flow diagram of a method for transmitting a message to a wireless communication device, in accordance with an embodiment of the present invention; and

FIG. 5 illustrates a flow diagram of a method for tracking and receiving a confirmation, in accordance with an embodiment of the present invention;

### DETAILED DESCRIPTION

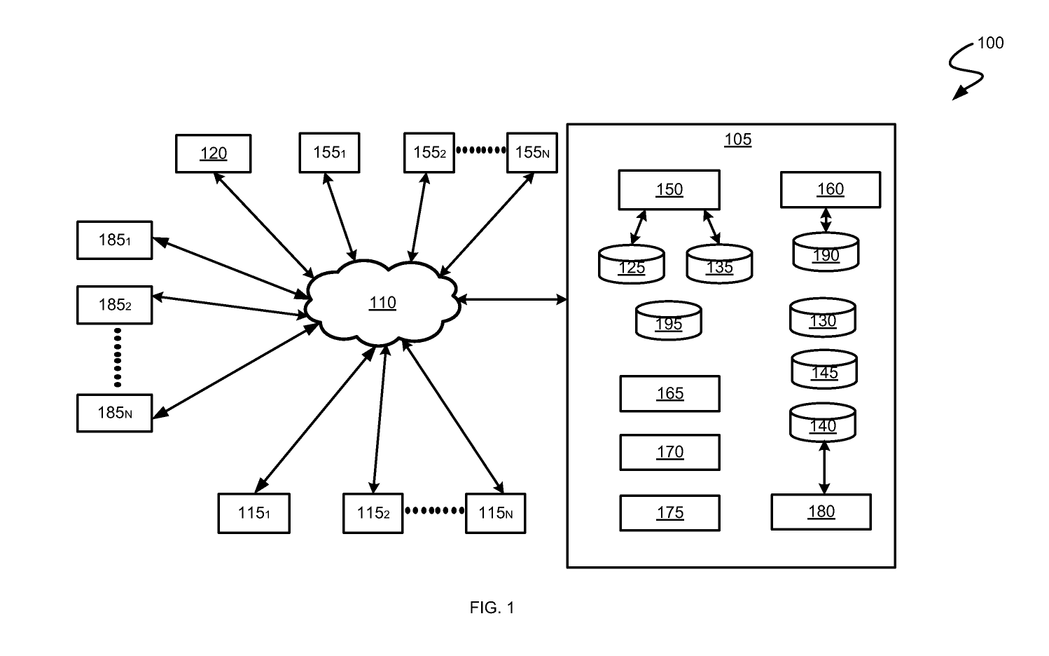

FIG. 1 illustrates a block diagram of a system 100 delivering one or more gift certificates and/or one or more gift cards to one or more recipients over a communication network 110, in accordance with an embodiment of the present invention. This figure only portrays one variation of the myriad of possible system configurations. The present invention can function in a variety of computing environments; such as, a distributed computer system, a centralized computer system, a standalone computer system, or the like. One skilled in the art will appreciate that the system 100 may or may not contain all the components listed below.

The system 100 includes a host processor 105, at least one communication network 110, one or more user devices 115₁, 115₂ . . . 115ₙ, at least one retailer device 120, one or more advertiser devices 155₁, 155₂ . . . 155ₙ and one or more wireless devices 185₁, 185₂ . . . 185ₙ. The at least one retailer device 120 and the advertiser devices 155 are coupled to the communication network 110.

The host processor 105 is coupled to the communication network 110 to communicate a multiple of electronic communication of a multiple of messages to the wireless devices 185₁, 185₂ . . . 185ₙ The user devices 115₁, 115₂ . . . 115ₙ are coupled to the communication network 110 in order to select the one or more gift certificates and/or one or more gift cards to be delivered to the one or more recipients selected by one or more users.

In another embodiment of the present invention, the one or more wireless devices 185₁, 185₂ . . . 185ₙ are coupled to the communication network 110 in order select the one or more gift certificates and/or one or more gift cards for the one or more users via a give back option available to the one or more recipients.

The communication link between the communication network 110 and the host processor 105, the at least one retailer device 120, the advertiser devices 155₁, 155₂ . . . 155ₙ, the wireless devices 185₁, 185₂ . . . 185ₙ or the user devices 115₁, 115₂ . . . 115ₙ may be a physical link, a wireless link, a combination there of, or the like. The at least one retailer device 120, the advertiser devices 155₁, 155₂ . . . 155ₙ, the wireless devices 185₁, 185₂ . . . 185ₙ and the user devices 115₁, 115₂ . . . 115ₙ may be another computer system, a standalone device, a wireless device, a personal digital assistant or the like.

Each retailer device 120, each advertiser device 155 and each user device 115 are preferably equipped with a retailer interface, an advertiser interface and an user interface for accessing the communication network 110, for example, any standard web browser, such as Microsoft Internet Explorer®, Netscape Communicator® or the like. Each retailer device 120, each advertiser device 155 and each user device 115 are also preferably equipped with a storage device for storing application programs and data.

In one embodiment of the present invention, the host processor 105 may be remotely located from the at least one retailer device 120, the advertiser devices 155₁, 155₂ . . . 155ₙ, the wireless devices 185₁, 185₂ . . . 185ₙ and the user devices 115₁, 115₂ . . . 115ₙ.

The host processor 105 is generally shown and described as processing the selection of the one or more gift certificates and/or the one or more gift cards to the one or more recipients selected by the one or more users and delivering one or more gift certificates and/or one or more gift cards to the one or more recipients via the communication network 110 to the wireless devices 185. However, these two functions of the host processor 105 may be implemented on two distinct platforms, where one computer provides the processing function and a second computer provides the delivering function. The embodiments described throughout this disclosure and the term “host processor” is intended to encompass this distributed implementation as well as single entity host processor 105.

In one embodiment of the present invention, the host processor 105 may include any device capable of sending and receiving data across the communication network 110, and which provides adequate firewall and security against unauthorized access of proprietary data and confidential user information.

The host processor 105 may include a message compiler module 150, a response module 160, a validation module 165, an option module 170, a processing module 175, a confirmation module 180, a message database 125, an information database 130, an advertisement database 135, an account database 140, a dispatch information database 145, a distribution database 190 and a preference database 195.

In one embodiment of the present invention, the message database 125 of the host processor 105 stores a multiple of messages accessible to the one or more users, to the one or more recipients, to one or more advertisers and to a retailer. The multiple of messages includes information about the one or more gift certificates and/or the one or more gift cards. The information database 130 of the host processor 105 stores information of the one or more recipients by the one or more users.

In another embodiment of the present invention, the information database 130 of the host processor 105 stores information of the one or more users by the one or more recipients when the give back option is available to the one or more recipients.

In one embodiment of the present invention, the advertisement database 135 includes a multiple of advertising information corresponding to the multiple of messages stored in the message database 125. Consequently, upon the selection of the one or more gift certificates and/or the one or more gift cards from the message database 125 by the one or more users, the corresponding advertising information is integrated into the one or more gift certificates and/or the one or more gift cards via the message compiler module 150.

In one embodiment of the present invention, the multiple of advertising information are sponsored by a multiple of advertisers.

In one embodiment of the present invention, the one or more corresponding advertising information of the multiple of advertising information to be integrated with the one or more selected message may be personalized and easily customized, revised, scheduled and promoted by the one or more advertisers sponsoring the respective advertising information. Upon setting up an account with the account database 140 of the system 100, the system 100 provides a corporate name, payment information, an unique account number, a user name and password which will be assigned to the one or more advertisers. Upon subsequent access to a website, the one or more advertisers may view the status of existing advertising information, edit the advertising information that is to be transmitted, or create new advertising information.

The one or more advertisers access the host processor 105 via the advertiser interface to the information stored in the advertisement database 135 by entering username and password or other account information in the account database 140. The list of advertisers who have registered with the system 100 are maintained in the account database 140. The one or more advertisers may access account information stored in the account database 140. The one or more advertisers add, remove and edit a multiple of advertising information stored in the advertisement database 135.

In one embodiment of the present invention, the appropriate one or more advertisement information to be integrated with the one or more selected messages is determined by the one or more advertisers. The one or more advertisers may select the one or more gift certificates and/or the one or more gift cards retrieved from the message database 125, to which the one or more advertising information should be integrated by the message compiler module 150.

In one embodiment of the present invention, the message compiler module 150 compiles the selected one or more gift certificates and/or the selected one or more gift cards from the multiple of messages stored in the message database 125 and the advertising information retrieved from the advertisement database 135 to form each message content to be transmitted to the wireless devices 185.

In one embodiment of the present invention, the advertising information retrieved from the advertisement database 135 are embedded as a substantive feature of the one or more gift certificates and/or the one or more gift cards selected from the multiple of messages stored in the message database 125.

In another embodiment of the present invention, the advertising information retrieved from the advertisement database 135 is integrally associated with the respective message content to be transmitted to the wireless devices 185 by the message compiler module 150.

In one embodiment of the present invention, the confirmation module 180 is operably coupled to the account database 140 to store a confirmation of a transmitted message associated with the respective advertiser sponsoring the advertising information in the transmitted message of the transmitted message content. The response module 160 provides a notification of a response received from the one or more wireless communication devices 185 of the one or more recipients of the transmitted message content to the one or more users and to the one or more advertisers sponsoring the advertising information in the transmitted message of the transmitted message content.

In one embodiment of the present invention, the response received by the response module 160 includes information about a delivery success status of the transmitted message content or a delivery failure status of the transmitted message content.

In one embodiment of the present invention, the confirmation of the transmitted message content includes an acceptance of the transmitted message content.

In another embodiment of the present invention, the confirmation of the transmitted message content includes a rejection of the transmitted message content.

In yet another embodiment of the present invention, the confirmation of the transmitted message content includes a forwarding of the transmitted message content.

In yet another embodiment of the present invention, the confirmation of the transmitted message content includes a delivery status of the transmitted message content.

In one embodiment of the present invention, the validation module 165 determines a validity of the transmitted message content.

In one embodiment of the present invention, the option module 170 determines an availability of a multiple of options available in the one or more transmitted messages of the transmitted message contents. The option module 170 also determines an availability of a forwarding option to forward the one or more transmitted message contents to another person by the one or more recipients. Further, the option module 170 determines an availability of a give back option of the one or more gift certificates and/or the one or more gift cards to the one or more users by the one or more recipients.

In one embodiment of the present invention, the processing module 175 processes an order of the selected one or more options from the multiple of options available in the transmitted messages of the one or more transmitted message content for shipment to the one or more recipients.

In one embodiment of the present invention, the preference database 195 collects and stores information regarding user preferences based on user selection of the one or more messages from the multiple of messages stored in the message database 125. The system 100 provides targeted advertisement information to the one or more recipients based upon the user preferences of the one or more messages from the multiple of messages stored in the message database 125. The one or more advertisement information are integrated to the user preferences of the one or more messages from the multiple of messages stored in the message database 125 by the message compiler module 150.

In one embodiment of the present invention, the message compiler module 150 prior to integrating the one or more advertisement information to the one or more selected message performs an analysis by reviewing the account database 140 which is regularly updated by the confirmation module 180, to make certain that the one or more recipients are not repetitively receiving the similar advertisement information.

In one embodiment of the present invention, the distribution database 190 stores a pending status of the multiple of message contents to be transmitted to the multiple of wireless communication devices 185.

In one embodiment of the present invention, the dispatch information database 145 stores details of shipping information of the one or more recipients and/or the one or more users.

In one embodiment of the present invention, the multiple of messages includes of a text, a video, a graphic information, a multimedia information, an audio information and the like.

In one embodiment of the present invention, the wireless communication devices 185 are a cellular telephone, an interactive pager, a networked personal digital assistant and the like.

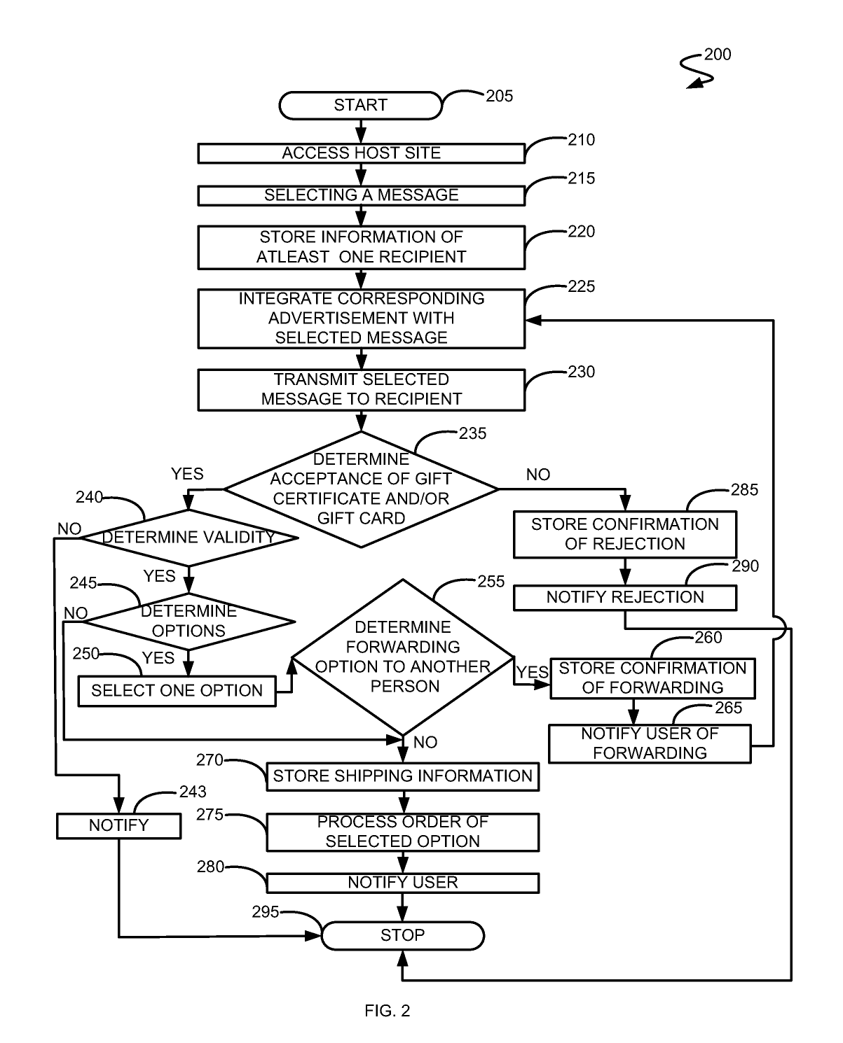

FIG. 2 illustrates a flow diagram of a method 200 of delivering one or more gift certificates and/or one or more gift cards to one or more recipients over the communication network 110 (of FIG. 1), in accordance with an embodiment of the present invention. The method 200 begins at step 205 and proceeds to step 210. At step 210, the method 200 includes accessing a host site interface over the communication network 110 by the one or more users and/or the retailer. In one embodiment of the present invention, a browser interface is provided at the user devices 115 (of FIG. 1) and/or at the retailer device 120 (of FIG. 1) or any other suitable type of connection hardware. At step 215, the one or more users are presented with a wide variety of message categories and/or themes stored in the message database 125 (of FIG. 1). The one or more users may browse, preview or search among the available categories and/or themes to aid in his or her selection of message. In one embodiment of the present invention, the wide variety of message categories and/or themes includes information about the one or more gift certificates and/or the one or more gift cards. The one or more gift certificates and/or the one or more gift cards may be for one or more specific products, a multiple of services, a specific amount of credit and the like. In one embodiment of the present invention, the one or more users are one or more senders of the transmitted message content to the one or more recipients.

In another embodiment of the present invention, the retailer selects a purchased gift certificate and/or a purchased gift card from the message database 125. The purchased gift certificate and/or the purchased gift card are brought by one or more customers at retailer point of sale.

At step 220, the one or more users and/or the retailer store information of the one or more recipients of the selected gift certificate and/or the selected gift card in the information database 130 (of FIG. 1). At step 225, upon selection of the one or more gift certificates and/or the one or more gift cards from the message database 125 by the one or more users and/or retailer, the message compiler module 150 (of FIG. 1) of the system 100 (of FIG. 1) integrates a corresponding advertising information retrieved from the advertisement database 135 (of FIG. 1) of the system 100 with the selected message from the multiple of messages to form a basis for an electronic communication. The selected message includes information about the selected gift certificate and/or the selected gift card. The advertising information is embedded as a substantive feature of the one or more gift certificates and/or the one or more gift cards selected from the multiple of messages. The advertisement database 135 includes a multiple of advertising information corresponding to the multiple of messages. In one embodiment of the present invention, a multiple of advertising information are sponsored by a multiple of advertisers. At step 230, the selected message from the multiple of messages integrated with the corresponding advertising information retrieved from the advertisement database 135 to form a message content is transmitted to the one or more recipients via the electronic communication to the one or more wireless communication devices 185 (of FIG. 1). At step 235, a determination is made as to whether the one or more gift certificates and/or the one or more gift cards from the transmitted message content have been accepted by the one or more recipients. If the one or more gift certificates and/or the one or more gift cards from the transmitted message content have been accepted by the one or more recipients option “YES”, the method 200 proceeds to step 240. At step 240, a determination is made as to whether the one or more gift certificates and/or the one or more gift cards from the transmitted message content are valid by the validation module 165 (of FIG. 1) of the system 100. If the one or more gift certificates and/or the one or more gift cards from the transmitted message content are not valid option “NO”, the method 200 proceeds to step 243. At step 243, the one or more users are notified about the non-validation of the transmitted message content by the response module 160 (of FIG. 1) of the system 100. The method 200 proceeds to step 295.

In one embodiment of the present invention, if the one or more gift certificates and/or the one or more gift cards from the transmitted message content are valid option “YES”, the method 200 proceeds to step 245. In one embodiment of the present invention, another message is transmitted to the one or more recipients on the acceptance of the one or more gift certificates and/or the one or more gift cards from the transmitted message content. Another message includes details about a redemption information, one or more product codes, one or more issuance identifier and the like. The one or more product codes and the one or more issuance identifiers include a pin number or one or more bar codes or one or more Q codes and the like. At step 245, a determination is made as to whether a multiple of options in the transmitted message content are available by the option module 170 (of FIG. 1) of the system 100. If the multiple of options in the transmitted message content are not available option “NO”, the method 200 proceeds to step 270.

In one embodiment of the present invention, if the multiple of options in the transmitted message content are available option “YES”, the method 200 proceeds to step 250. At step 250, the one or more recipients' selects at least one option from the multiple of options available in the transmitted message content. At step 255, a determination is made as to whether forwarding option of the one or more gift certificates and/or the one or more gift cards from the transmitted message content to another person by the one or more recipients are available by the option module 170. If the forwarding option of the transmitted message to another person by the one or more recipients is available option “YES”, the method 200 proceeds to step 260. At step 260, a confirmation of the forwarding of the transmitted message is stored in the account database 140 (of FIG. 1) associated with the respective advertiser sponsoring the advertising information in the transmitted message of the transmitted message content by the confirmation module 180 (of FIG. 1) of the system 100. At step 265, the forwarding of the transmitted message content by the one or more recipients to another person is notified to the one or more users by the response module 160. In another embodiment of the present invention, the one or more recipients are the one or more senders of the forwarded transmitted message content to the one or more another persons. The method 200 proceeds to the step 295.

In one embodiment of the present invention, if the one or more gift certificates and/or the one or more gift cards from the transmitted message content have not been accepted by the one or more recipients option “NO”, the method 200 proceeds to step 285. At step 285, the confirmation of rejection of the transmitted message content by the one or more recipients is stored in the account database 140 associated with the respective advertiser sponsoring the advertising information of the transmitted message content by the confirmation module 180. At step 290, a notification of the rejection of the transmitted message content received via the wireless communication devices 185 is sent to the one or more users and to the one or more respective advertisers of the multiple of advertisers sponsoring the advertising information in the transmitted message content by the response module 160. The method 200 proceeds to step 295.

In one embodiment of the present invention, if the forwarding option of the transmitted message content to another person by the one or more recipients is not available option “NO”, the method 200 proceeds to step 270. At step 270, details of shipping information of the one or more recipients are stored in the dispatch information database 145 (of FIG. 1) of the system 100 (of FIG. 1). At step 275, an order of the selected one or more options from the multiple of options available in the transmitted message content are processed by the processing module 175 (of FIG. 1) of the system 100 for shipment to the one or more recipients. At step 280, the one or more users are notified about the order confirmed by the one or more recipients by the response module 160. The method 200 proceeds to step 295. At step 295, the method 200 ends.

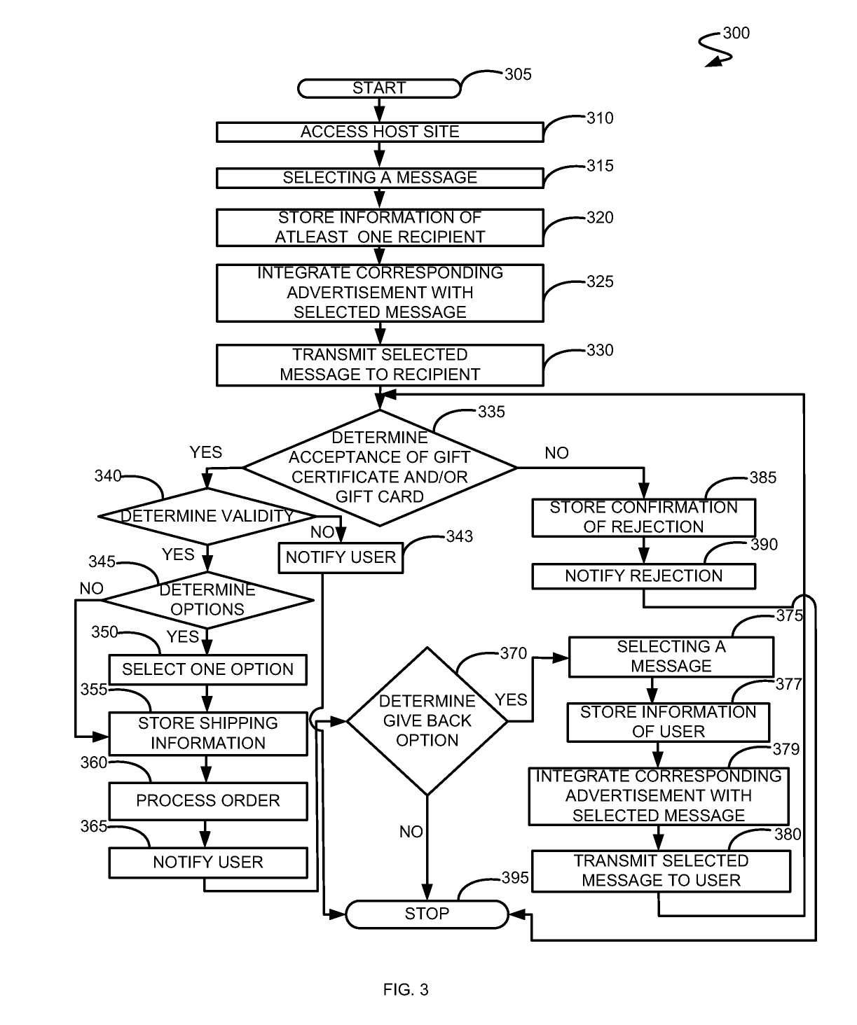

FIG. 3 illustrates a flow diagram of a method 300 of delivering one or more gift certificates and/or one or more gift cards to one or more recipients over the communication network 110, in accordance with an alternate embodiment of the present invention. The method 300 begins at step 305 and proceeds to step 310. At step 310, the method 300 includes accessing a host site interface over the communication network 110 by the one or more users and/or the retailer. In one embodiment of the present invention, a browser interface is provided at the user devices 115 (of FIG. 1) and/or at the retailer device 120 (of FIG. 1) or any other suitable type of connection hardware. At step 315, the one or more users are presented with a wide variety of message categories and/or themes stored in the message database 125 (of FIG. 1). The one or more users may browse, preview or search among the available categories and/or themes to aid in his or her selection of message. In one embodiment of the present invention, the wide variety of message categories and/or themes includes information about the one or more gift certificates and/or the one or more gift cards. The one or more gift certificates and/or the one or more gift cards may be for one or more specific products, a multiple of services, a specific amount of credit and the like. In one embodiment of the present invention, the one or more users are one or more senders of the transmitted message content to the one or more recipients.

In another embodiment of the present invention, the retailer selects a purchased gift certificate and/or a purchased gift card from the message database 125. The purchased gift certificate and/or the purchased gift card are brought by one or more customers at retailer point of sale.

At step 320, the one or more users and/or the retailer store information of the one or more recipients of the selected gift certificate and/or the selected gift card in the information database 130 (of FIG. 1). At step 325, upon selection of the one or more gift certificates and/or the one or more gift cards from the message database 125 by the one or more users and/or retailer, the message compiler module 150 (of FIG. 1) of the system 100 (of FIG. 1) integrates a corresponding advertising information retrieved from the advertisement database 135 (of FIG. 1) of the system 100 with the selected message from the multiple of messages to form a basis for an electronic communication. The selected message includes information about the selected gift certificate and/or the selected gift card. The advertising information is embedded as a substantive feature of the one or more gift certificates and/or the one or more gift cards selected from the multiple of messages. The advertisement database 135 includes a multiple of advertising information corresponding to the multiple of messages. In one embodiment of the present invention, a multiple of advertising information are sponsored by a multiple of advertisers. At step 330, the selected message from the multiple of messages integrated with the corresponding advertising information retrieved from the advertisement database 135 to form a message content is transmitted to the one or more recipients via the electronic communication to the one or more wireless devices 185 (of FIG. 1). At step 335, a determination is made as to whether the one or more gift certificates and/or the one or more gift cards from the transmitted message content have been accepted by the one or more recipients. If the one or more gift certificates and/or the one or more gift cards from the transmitted message content by the one or more recipients have been accepted by the one or more recipients option “YES”, the method 300 proceeds to step 340. At step 340, a determination is made as to whether the one or more gift certificates and/or the one or more gift cards from the transmitted message content are valid by the validation module 165 (of FIG. 1) of the system 100. If the one or more gift certificates and/or the one or more gift cards from the transmitted message content are not valid option “NO”, the method 300 proceeds to step 343. At step 343, the one or more users are notified about the non-validation of the transmitted message by the response module 160 (of FIG. 1) of the system 100. The method 300 proceeds to step 395.

In one embodiment of the present invention, if the one or more gift certificates and/or the one or more gift cards from the transmitted message content are valid option “YES”, the method 300 proceeds to step 345. In one embodiment of the present invention, another message is transmitted to the one or more recipients on the acceptance of the one or more gift certificates and/or the one or more gift cards from the transmitted message content. Another message includes details about a redemption information, one or more product codes, one or more issuance identifier and the like. The one or more product codes and the one or more issuance identifiers include a pin number or one or more bar codes or one or more Q codes and the like. At step 345, a determination is made as to whether a multiple of options in the transmitted message content are available by the option module 170 (of FIG. 1) of the system 100. If the multiple of options in the transmitted message content are not available option “NO”, the method 300 proceeds to step 355.

In one embodiment of the present invention, if the multiple of options in the transmitted message content are available option “YES”, the method 300 proceeds to step 350. At step 350, the one or more recipients' selects at least one option from the multiple of options available in the transmitted message content. At step 355, details of shipping information of the one or more recipients are stored in the dispatch information database 145 (of FIG. 1) of the system 100 (of FIG. 1). At step 360, an order of the selected one or more options from the multiple of options available in the transmitted message content are processed by the processing module 175 (of FIG. 1) of the system 100 for shipment to the one or more recipients. In one embodiment of the present invention, an order of the one or more gift certificates and/or the one or more gift cards from the transmitted message are processed by the processing module 175 (of FIG. 1) of the system 100 for shipment to the one or more recipients. At step 365, the one or more users are notified about the order confirmed by the one or more recipients by the response module 160. At step 370, a determination is made as to whether give back option of the one or more gift certificates and/or the one or more gift cards to the one or more users by the one or more recipients are available by the option module 170. If the give back option of the one or more gift certificates and/or the one or more gift cards to the one or more users by the one or more recipients are available option “YES”, the method 300 proceeds to step 375. At step 375, the one or more recipients may access a wide variety of message categories and/or themes stored in the message database 125. The one or more recipients may browse, preview or search among the available categories and/or themes and/or options to aid in his or her selection of message. In one embodiment of the present invention, the wide variety of message categories and/or themes and/or options includes information about the one or more gift certificates and/or the one or more gift cards. The one or more gift certificates and/or the one or more gift cards may be for one or more specific products, a multiple of services, a specific amount of credit and the like. At step 377, the one or more recipients store information of the one or more users in the information database 130. At step 379, upon selection of the one or more gift certificates and/or the one or more gift cards from the message database 125 by the one or more recipients, the message compiler module 150 integrates the corresponding advertising information retrieved from the advertisement database 135 with the selected message from the multiple of messages to form a basis for the electronic communication. The advertising information is embedded as a substantive feature of the one or more gift certificates and/or the one or more gift cards selected from the multiple of messages. At step 380, the selected message from the multiple of messages integrated with the corresponding advertising information retrieved from the advertisement database 135 to form the message content is transmitted to the one or more users via the electronic communication to the one or more wireless communication devices 185. The method 300 proceeds to step 335. However, the steps from step 335 to step 365 are repeated whereby the one or more users (as explained above) become the one or more recipients and vice versa.

In one embodiment of the present invention, if the give back option of the one or more gift certificates and/or the one or more gift cards to the one or more users by the one or more recipients is not available option “NO”, the method 300 proceeds to step 395. At step 395, the method 300 ends.

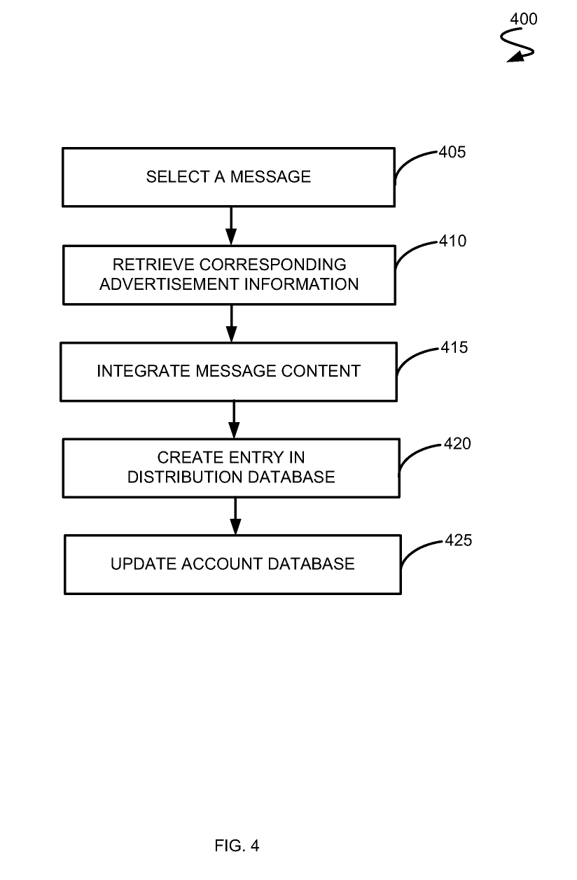

FIG. 4 illustrates a flow diagram of a method 400 for transmitting a message to the wireless communication device 185 (of FIG. 1), in accordance with an embodiment of the present invention. At step 405, the one or more users select the one or more messages from the multiple of messages stored in the message database 125 (of FIG. 1) to designate to the one or more recipients. In one embodiment of the present invention, the wide variety of message categories and/or themes includes information about the one or more gift certificates and/or the one or more gift cards. The one or more gift certificates and/or the one or more gift cards may be for one or more specific products, a multiple of services, a specific amount of credit and the like. At step 410, a corresponding advertising information of the selected one or more messages from the multiple of messages are retrieved from the advertisement database 135 (of FIG. 1) by the message compiler module 150 (of FIG. 1) of the system 100 (of FIG. 1). At step 415, upon selection of the one or more gift certificates and/or the one or more gift cards from the message database 125 by the one or more users and/or the retailer, the message compiler module 150 integrates the corresponding advertising information with the one or more messages selected from the multiple of messages to form a message content. The message content forms a basis for the electronic communication to the one or more wireless devices 185. In one embodiment of the present invention, the one or more advertising information are embedded as a substantive feature of the one or more gift certificates and/or the one or more gift cards selected from the multiple of messages. At step 420, an entry of the message content is created in the distribution database 190 (of FIG. 1). The distribution database 190 tracks a delivery status of pending messages until they are deleted from the list as confirmed and delivered messages or time-out failed deliveries. At step 425, the account database 140 is updated to indicate that the message content was generated and placed in the distribution database 190 at a certain point of time for attempted delivery. The system 100 scans through the distribution database 190 and attempts to deliver the message content generated by the message compiler module 150 to the wireless communication devices 185.

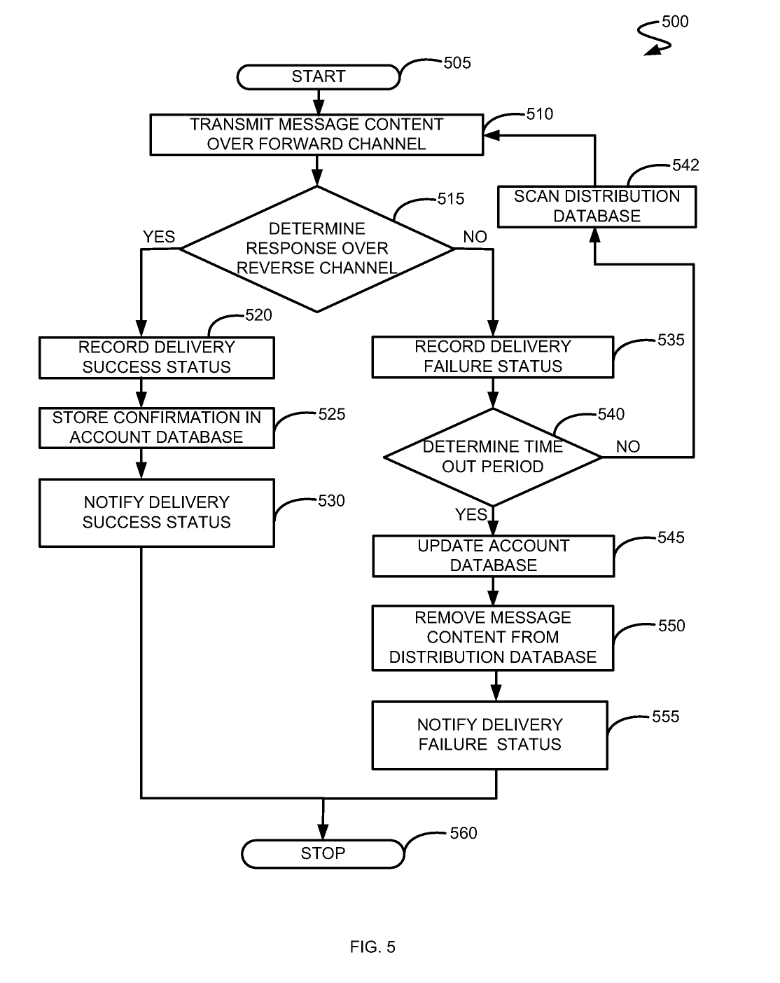

FIG. 5 illustrates a flow diagram of a method 500 for tracking and receiving a confirmation, in accordance with an embodiment of the present invention. The method 500 begins at step 505 and proceeds to step 510. At step 510, the method 500 includes transmitting the message content generated by the message compiler module 150 (of FIG. 1) to the one or more recipients via the electronic communication over a forward control channel to the wireless communication devices 185 (of FIG. 1) of the one or more recipients. At step 515, a determination is made as to whether a response is received from the wireless devices 185 of the one or more recipients of the transmitted message content over a reverse control channel by the response module 160 (of FIG. 1) of the system 100. If the response is received by the wireless communication devices 185 of the one or more recipients of the transmitted message content over a reverse control channel by the response module 160 option “YES”, the method 500 proceeds to step 520. At step 520, a delivery success status of the transmitted message content is recorded in the distribution database 190 (of FIG. 1) of the system 100 (of FIG. 1) by the response module 160. In one embodiment of the present invention, the message content transmitted to the wireless communication devices 185 is removed from the distribution database 190 on receiving the response by the response module 160 and the delivery success status of the message content transmitted to the wireless communication devices 185 is subsequently recorded in the distribution database 190. At step 525, a confirmation of the transmitted message content is stored in the account database 140 (of FIG. 1) of the system 100 associated with the respective advertiser of the multiple of advertisers sponsoring the advertising information of the transmitted message in the transmitted message content by the confirmation module 180 (of FIG. 1) of the system 100. At step 530, a notification of the response received from the wireless communication devices 185 of the one or more recipients of the transmitted message content by the distribution database 190 is forwarded to the advertiser sponsoring the advertisement in the transmitted message content by the response module 160. The notification of the response received from the wireless devices 185 of the one or more recipients of the transmitted message content is also forwarded to the one or more senders of the transmitted message content. In one embodiment of the present invention, the response includes information about delivery success status of the transmitted message content to the wireless communication devices 185. The method 500 proceeds to step 560.

In one embodiment of the present invention, if the response is not received from the wireless devices 185 of the one or more recipients of the transmitted message content over the reverse control channel option “NO”, the method 500 proceeds to step 535. At step 535, a delivery failure status of the transmitted message content is recorded in the distribution database 190 by the response module 160. At step 540, a determination is made as to whether the transmitted message content remains pending in the distribution database 190 after a stipulated “time out” period. If the transmitted message content doesn't remains pending in the distribution database 190 after a stipulated “time out” period option “NO”, the method 500 proceeds to step 542. At step 542, the system 100 scans the distribution database 190 and attempts to deliver the transmitted message content to the wireless devices 185 of the one or more recipients. The method 500 proceeds to step 510.

In one embodiment of the present invention, if the transmitted message content remains pending in the distribution database 190 after a stipulated “time out” period option “YES”, the method 500 proceeds to step 545. At step 545, the account database 140 associated with the respective advertiser of the multiple of advertisers sponsoring the advertising information of the transmitted message in the transmitted message content is updated by the confirmation module 180. The confirmation module 180 stores a confirmation of the transmitted message content is not delivered to the wireless devices 185 of the one or more recipients. At step 550, the transmitted message content is deleted from the distribution database 190. At step 555, a notification of the response received by the distribution database 190 is forwarded to the advertiser sponsoring the advertisement in the transmitted message content by the response module 160. The notification of the response received from the wireless devices 185 of the one or more recipients of the transmitted message content is also forwarded to the one or more senders of the transmitted message content. In one embodiment of the present invention, the response includes information about delivery failure status of the transmitted message content to the wireless communication devices 185. At step 560, the method 500 ends.

Therefore, as can be seen, embodiments of the present invention are not limited to the transmission of short text messages or multimedia messaging services to the wireless devices. The wireless devices may be mobile phone, handheld units, or fixed units within automobiles or other types of personal transportation vehicles, or within buses, airplanes, or other public transportation systems. As described above, the message content may include short text messages, graphics, audio or speech messages, video, or a combination of any of the above.

As described generally above, the one or more advertisers may customize the promotion according to the advertiser's preferences. The advertiser may enter the local addresses of the advertised establishments (For e.g., a McDonald's restaurant which may be located in two or more locations in a given area) in the advertising information. The advertiser may also wish to transmit the one or more advertisements during periodic intervals throughout each day, during particular days of the week (For e.g., weekends), during certain times of the day (For e.g., lunch hour), during certain times of the month (For e.g., the last week of each month). As also indicated above, the advertising information that is transmitted to the wireless communication devices may include promotional messages, discount coupons, or a combination of both.

In the foregoing specification, specific embodiments of the present invention have been described. However, one of ordinary skill in the art will appreciate that various modifications and changes can be made without departing from the spirit and scope of the present invention as set forth in the various embodiments discussed above and the claims that follow. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements as described herein.

We claim:

1. A method of delivering at least one gift certificate and/or at least one gift card to at least one recipient over a communication network, said method comprising:
storing a plurality of messages in a message database, said plurality of messages comprising information about said at least one gift certificate and/or said at least one gift card;
selecting a message from said plurality of messages stored in said message database;
storing information of at least one recipient in an information database;
selecting said at least one recipient from said information database for transmitting said selected message from said plurality of messages stored in said message database;
integrating a corresponding advertising information with at least one message selected from said plurality of messages to form a basis for an electronic communication, such that said advertising information is embedded as a substantive feature of said at least one gift certificate and/or said at least one gift card selected from said plurality of messages; and
transmitting a message content comprising said selected message from said plurality of messages and said corresponding advertising information to said at least one recipient via said electronic communication to said at least one wireless communication device.

2. The method of delivering at least one gift certificate and/or at least one gift card according to claim 1, wherein said method further comprises:
transmitting said message content to said recipient via said electronic communication over a forward control channel to said at least one wireless communication device of said at least one recipient;
receiving a response from said at least one wireless communication device of said at least one recipient of said transmitted message content over a reverse control channel;
storing a confirmation of said transmitted message content in an account database associated with a respective advertiser of said plurality of advertisers sponsoring said advertising information in said transmitted message content; and
providing a notification of said response to an user and said respective advertiser of said plurality of advertisers sponsoring said advertisement in said transmitted message content.

3. The method of delivering at least one gift certificate and/or at least one gift card according to claim 2, wherein said method further comprises:
accepting said at least one gift certificate and/or said at least one gift card from said transmitted message content by said at least one recipient;
determining a validity of said transmitted message content; and
determining an availability of a plurality of options available in said transmitted message content.

4. The method of delivering at least one gift certificate and/or at least one gift card according to claim 3, wherein said method further comprises selecting at least one option from said plurality of options available in said transmitted message content.

5. The method of delivering at least one gift certificate and/or at least one gift card according to claim 4, wherein said method further comprises:
storing details of shipping information in a dispatch information database; and
processing an order of said selected at least one option from said plurality of options available in said transmitted message content for shipment to said at least one recipient.

6. The method of delivering at least one gift certificate and/or at least one gift card according to claim 3, wherein on said acceptance of said at least one gift certificate and/or said at least one gift card by said recipient another message is transmitted to said recipient, said another message comprising a redemption information, at least one product code, at least one issuance identifier and the like.

7. The method of delivering at least one gift certificate and/or at least one gift card according to claim 2, wherein said method further comprises:
rejecting said at least one gift certificate and/or said at least one gift card from said transmitted message content by said at least one recipient;
storing a confirmation of said rejection of said transmitted message content in said account database associated with said respective advertiser of said plurality of advertisers sponsoring said advertising information of said transmitted message content; and
providing a notification of said rejection of said transmitted message content.

8. The method of delivering at least one gift certificate and/or at least one gift card according to claim 2, wherein said method further comprises:
forwarding said at least one gift certificate and/or said at least one gift card from said transmitted message content to another person by said at least one recipient;
storing a confirmation of said forwarding of said transmitted message content in said account database associated with said respective advertiser of said plurality of advertisers sponsoring said advertising information of said transmitted message content; and
providing a notification of said forwarding of said transmitted message content.

9. The method of delivering at least one gift certificate and/or at least one gift card according to claim 2, wherein said method further comprises:
providing a give back option to said at least one recipient;
selecting a message from said plurality of messages stored in said message database;
storing information of said user in said information database;
selecting said user from said information database for transmitting said message from said plurality of messages stored in said message database;
integrating a corresponding advertising information with at least one message selected from said plurality of messages to form a basis for said electronic communication, such that said advertising information is embedded as a substantive feature of said one gift certificate and/or said one gift card selected from said plurality of messages; and
transmitting a message content comprising said selected message from said plurality of messages and said corresponding advertising information to said user via said electronic communication to said at least one wireless communication device.

10. The method of delivering at least one gift certificate and/or at least one gift card according to claim 2, wherein confirmation of said transmitted message content includes an acceptance or a rejection or a forwarding and/or a delivery status of said transmitted message content.

11. The method of delivering at least one gift certificate and/or at least one gift card according to claim 2, wherein said response comprises information about a delivery success status or a delivery failure status of said transmitted message content.

12. The method of delivering at least one gift certificate and/or at least one gift card according to claim 1, wherein said plurality of messages comprises of a text, a video, a graphic information, a multimedia information, an audio information and the like.

13. The method of delivering at least one gift certificate and/or at least one gift card according to claim 1, wherein said wireless communication device is a cellular telephone, an interactive pager, a networked personal digital assistant, an automotive navigational system and the like.

14. A system of delivering at least one gift certificate and/or at least one gift card to at least one recipient over a communication network, said system comprising:
a host processor operable to transmit a plurality of message contents;
a message database for storing a plurality of messages, said plurality of messages comprising information about said at least one gift certificate and/or said at least one gift card;
an information database for storing information of at least one recipient;
wherein each message content comprises at least one message selected from said plurality of messages and an advertising information, such that said advertising information is embedded as a substantive feature of said at least one gift certificate and/or said at least one gift card selected from said plurality of messages or is integrally associated with said respective message content.

15. The system of delivering at least one gift certificate and/or at least one gift card according to claim 14, further comprising a message compiler module, said message compiler module compile said selected at least one gift certificate and/or said selected at least one gift card from said plurality of messages and said advertising information to form said each message content.

16. The system of delivering at least one gift certificate and/or at least one gift card according to claim 14, further comprising an advertisement database, said advertisement database comprising a plurality of advertising information corresponding to said plurality of messages such that upon selection of said at least one gift certificate and/or said at least one gift card from said message database by said at least one user, said corresponding advertising information is integrated into said at least one gift certificate and/or said at least one gift card via said message compiler module.

17. The system of delivering at least one gift certificate and/or at least one gift card according to claim 14, further comprising:
a confirmation module operably coupled to an account database, said account database store a confirmation of said transmitted message associated with said respective advertiser sponsoring said advertising information in said transmitted message of said transmitted message content;
a response module to provide a notification of a response received from said at least one wireless communication device of said transmitted message content to said at least one user and said advertiser sponsoring said advertising information in said transmitted message of said transmitted message content;
a validation module to determine a validity of said transmitted message of said transmitted message content;
an option module to determine an availability of a plurality of options available in said transmitted message of said transmitted message content, to determine an availability of a forwarding option to forward said transmitted message content to another person by said at least one recipient and to determine an availability of a give back option of said at least one gift certificate and/or said at least one gift card to said at least one user by said at least one recipient;
a processing module to process an order of said selected at least one option from said plurality of options available in said transmitted message of said transmitted message content for shipment to said at least one recipient;
a preference database collecting and storing information regarding user preferences based on user selection of at least one message from said plurality of messages;
a distribution database stores a pending status of said plurality of message contents to be transmitted to said plurality of wireless communication devices; and
a dispatch information database storing details of shipping information;

18. The system of delivering at least one gift certificate and/or at least one gift card according to claim 17, wherein confirmation of said transmitted message content includes an acceptance or a rejection or a forwarding or a delivery status of said transmitted message content.

19. The system of delivering at least one gift certificate and/or at least one gift card according to claim 17, wherein said response comprises information about a delivery success status or a delivery failure status of said transmitted message content.

20. The system of delivering at least one gift certificate and/or at least one gift card according to claim 13, wherein said plurality of messages comprises of a text, a video, a graphic information, a multimedia information, an audio information and the like.

21. The system of delivering at least one gift certificate and/or at least one gift card according to claim 13, wherein said wireless communication device is a cellular telephone, an interactive pager, a networked personal digital assistant and the like.
